(19) United States
(12) Patent Application Publication
(10) Pub. No.: US 2014/0087714 A1
(43) Pub. Date: Mar. 27, 2014

(54) DEVICE CONTROL METHOD AND APPARATUS

(71) Applicant: Tencent Technology (Shenzhen) Company Limited, Shenzhen (CN)

(72) Inventors: Xuan LUO, Shenzhen (CN); Jun Yan, Shenzhen (CN)

(73) Assignee: Tencent Technology (Shenzhen) Company Limited, Shenzhen (CN)

(21) Appl. No.: 14/086,920

(22) Filed: Nov. 21, 2013

Related U.S. Application Data
(63) Continuation of application No. PCT/CN2013/076932, filed on Jun. 7, 2013.

(30) Foreign Application Priority Data
Sep. 26, 2012 (CN) 201210361193.4

(51) Int. Cl. H04W 8/22

(52) U.S. Cl. CPC H04W 8/22
USPC 455/420

(57) ABSTRACT

A method and apparatus for controlling a device is provided. The method includes: a mobile device obtaining device information of a controlled device; the mobile device establishing a connection with the controlled device based on the device information, and inquiring service information of the controlled device via the established connection, the service information including service information regarding device control; the mobile device establishing a device control service connection with the controlled device based on the service information regarding device control; the mobile device generating control information based on user operation, and transmitting the control information to the controlled device via the device control service connection, to control the controlled device based on the control information. The disclosed method can facilitate, for example, device control over a LAN.

### CROSS REFERENCE TO RELATED APPLICATIONS

This application is a U.S. continuation application under 35 U.S.C. §111(a) claiming priority, under 35 U.S.C. §120 and 365(c), to International Application No. PCT/CN2013/076932 filed on Jun. 7, 2013, which claims the priority benefit of Chinese Patent Application No. 201210361193.4, filed on Sep. 26, 2012, the contents of both the PCT application and the Chinese application are incorporated by reference herein in their entirety for all purposes.

### FIELD

This relates generally to network communication, and in particular, to a device-control method and apparatus.

### BACKGROUND

Computer networks have become prevalent in the current environment. A local area network (LAN) such as a home network can have more and more terminal devices such as mobile phones and personal computers (PC) connected to it. The interactions among the devices are also becoming more frequent.

Because of the portability of the mobile terminals, more and more users wish to use a mobile terminal to control other devices in the household as a way of performing device control. However, this technology is not available in any of the currently-available technologies.

### SUMMARY

One of the problems that can be solved with embodiments of the present disclosure is to provide a device control method and apparatus to control at one device in a local area network (LAN).

To resolve the above-described problem, embodiments of the disclosure can provide a device control method. The method can include: a mobile terminal obtaining device information associated with a controlled device; the mobile terminal establishing a connection with the controlled device based on the obtained device information and inquiring service information of the controlled device via the established connection, the service information including device control service information; the mobile terminal establishing a device control service connection with the controlled device based on the device control service information; and the mobile terminal generating control information based on a user operation and transmitting the control information to the controlled device via the device control service connection for the controlled device to perform a local control operation based on the control information.

In another aspect, embodiments of the present disclosure can provide a device control apparatus for use in a mobile terminal. The apparatus can include a device discovering module that can obtain device information of a controlled device; a service inquiry module that inquires about service information associated with the controlled device based on the device information and the established connection, the service information including device control service information; a device control connecting module that can establish a device control service connection to the controlled device based on the device control service information; and a device control module that can generate control information based on a user operation and transmit the control information to the controlled device over the device control service connection for controlled device to perform a local control operation based on the control information.

In another aspect, embodiments of the disclosure can provide a mobile terminal including the above-described device control apparatus.

In some embodiments, the device control process can be realized through processes including discovering a device, discovering the device's device control service, and generating and transmitting of control information. This can provide a technical solution for device control among different devices on a LAN, thereby solving the problems with the existing technology and increasing the interactions among the devices on a LAN.

### BRIEF DESCRIPTION OF THE DRAWINGS

FIG. 1 illustrates the exemplary steps in a device control method, according to an embodiment of the present disclosure.

FIG. 2 is a flow chart illustrating the exemplary steps of a device control method on a LAN, according to an embodiment of the present disclosure.

FIG. 3 illustrates an embodiment in which a mobile phone and a PC are connected via the Wi-Fi network, according to an embodiment of the present disclosure.

FIG. 4 is a flowchart illustrating the exemplary steps of an embodiment, in which a mobile terminal (e.g., a mobile phone) and a controlled device (e.g., a PC) are connected via a WAN, according to an embodiment of the present disclosure.

FIG. 5 is a structure diagram of an exemplary device control apparatus, according to an embodiment of the present disclosure.

FIG. 6 is a block diagram illustrating the exemplary units of a device discovering module, according to an embodiment of the present disclosure.

FIG. 7 is block diagram illustrating an exemplary structure of a device control apparatus, according to an embodiment of the present disclosure.

### DETAILED DESCRIPTION

A detailed description of the technical solutions of the embodiments of the present disclosure is provided below in view of the accompanying drawings. It should be understood that the embodiments described below are representative embodiments of the present disclosure rather than a complete disclosure of the every possible embodiment. The present disclosure can also include any other embodiments that can be derived from these disclosed embodiments by a person with ordinary skill in the art without any additional inventive work. It is to be understood that other embodiments can be used and structural changes can be made without departing from the scope of the embodiments of this disclosure.

This disclosure generally relates to a method and apparatus for using one device to control the operation of at least one other device over a network. As referred hereinafter, devices can be any electronic device capable of connecting to a network through a wireless or wired network for transmitting and/or receiving data. Such devices can include, but are not limited to, PCs, Macs, desktop computers, laptop computers, tablet PCs, smartphones including iPhones, Android phones, Windows phones, and Blackberries, e-readers, in-car communication devices, televisions, gaming consoles and other consumer electronic devices with sufficient network capabilities.

Furthermore, the devices can also be referred to as terminals (i.e., “device” and “terminal” are interchangeable terminologies). For example, a mobile terminal can be any mobile devices and a controlled device can be any terminal on the network. A device that can control another device connected to the same network can be referred to as a controlling device or controlling terminal. In the embodiments discussed below, the controlling device/terminal can be a mobile terminal such as a mobile phone, smartphone, and tablet PC. The device that can be controlled by the controlling device/terminal can be referred to as the controlled device. In some of the embodiments discussed below, the controlled device can be a PC. In other embodiments, the controlled device can be, for example, a laptop, TV, or gaming console. In yet some other embodiments, the controlled device can also be a mobile device. As will be described in detail below, a controlling device can control multiple controlled devices, either simultaneously or individually. A controlled device can be controlled by multiple controlling devices. For example, a PC can receive control command from two smartphones. A device can be both a controlling device and a controlled device in that it can be used for controlling the operation on another device and also receive control command from another device.

As described in the embodiments below, in operation, the controlling device (e.g., a mobile terminal) and the at least one controlled device (e.g., a PC) can be connected to the same network. The network can be any computer network such as the Internet, a LAN, wide area network (WAN), cellular network, Wi-Fi network, and virtual private network (VPN). To perform remote control of one or more controlled devices, the controlling device can send out a broadcast including its own IP address or other connection information over the network (e.g., a LAN). One or more of the controlled devices can be discovered by responding to the broadcast with their own device information such as IP addresses. A connection (e.g., a TCP connection) can then be established between the devices based on this information. The controlling device can then obtain service information from the controlled device. The service information can indicate the type of services available at the controlled device. Some of these services can be referred to as “expanded services,” which can include, for example, a remote control service that can perform control operations locally on the controlled device based on control information received from the controlling device. Control information can correspond to one or more control operations and be transmitted over the established connection to a specific service port number associated with the remote control service. In various embodiments, the control information and other information exchanged between the controlling device and the controlled device can be in any protocol shared by the devices.

The controlling device and the at least one controlled device can also communicate through a shared account of an application running on both devices. The application can be, for example, an instant messaging application such as Microsoft's MSN Messenger or Tencent's QQ. It can also be any other network-based communication application that requires an account to transmit and receive information over a network. In various embodiments, the network can be the Internet or a WAN. A controlling device can perform remote control operations on one or more other devices logged into the same account as the controlling device. In particular, the controlling device and the one or more controlled device can be logged into the same application using the same account. Based on information associated with the account (e.g., account number, username, user ID, etc.), the controlling device can identify the controlled device(s) and connect to the controlled devices via, for example, a network server hosting the application. In addition, the server can route information including control commands between the controlling device and the controlled device(s).

The control information or control command generated from the control information can be for performing any control operations on the controlled device. The control information can be generated based on user input on the controlling device. The user input can of any type or in any form. For example, it can be touch input, gesture input, voice input, input via virtual or physical input devices such as keyboard and mouse, visual input received by a camera, or a combination of multiple inputs of the same type of different types. Touch input and gesture input can include single point and multi-point input. In some embodiments, the user input detected by the controlling device can be the same input for performing a desired operation locally on the controlled device. For example, the user can remotely move a cursor displayed on the controlled device (e.g., a tablet PC) by moving a finger on the screen of the controlling device (e.g., a smartphone).

Any control operations can be performed remotely on the controlled device in response to the control information/command received from the controlling device. Such control operations can include, for example, basic input operations such as a mouse click, cursor movement, page scrolling, text input, zooming, scaling, etc. They can also include application-specific operations. For example, game input can be received from the controlling device to play a game on the controlling device. For example, a user can use his smartphone as a remote control to play a driving game on a TV by tilting the smartphone in different directions to control a car in the driving game. The tilting input can be detected by an accelerometer in the smartphone and converted into a control command, which can be transmitted to a gaming console connected to the TV. The gaming console can update game actions in real time (e.g., moving the car) based on the control command.

In some embodiments, multiple controlling devices can perform remote control operations on a single controlled device at the same time. For example, in the driving game example, two (or more) smartphones (or other mobile devices) can be connected to the game console at the same time and transmit driving control information to the game console simultaneously to control two cars in the same race session. In fact, any type of remote control operations can be performed using the disclosed methods and apparatus of the disclosure. Detailed embodiments are described in the paragraphs below.

In other embodiments, a controlling device (e.g., mobile phone) can control multiple controlled devices at the same time. In particular, the controlling device can discover the multiple controlled devices using the same mechanism (e.g., sending out a broadcast including the IP address and/other connection information of the controlling device over the network). It can receive responses from the multiple devices and use the device information in each of these responses to connect to each of the controlled devices. Once connected, the controlling device can broadcast additional information such as control command via the connections to each of the controlled devices. In some embodiments, the multiple controlled devices can be on the same network (e.g., a LAN). In other embodiments, they can be on different networks (e.g., some on a LAN and others on a WAN). So long as the controlling device can connect to the different networks and transmit information over the different networks, it can perform remote control of the multiple controlled devices simultaneously. For example, the controlling device can send a control command over a TCP connection to one of the controlled devices and, at the same time, send the same command via an instant messaging account to another controlled device to perform the same operation on the multiple controlled devices. This enable a user to use his smartphone to, for example, initiate a download of the same video on both his laptop and tablet PC at the same time.

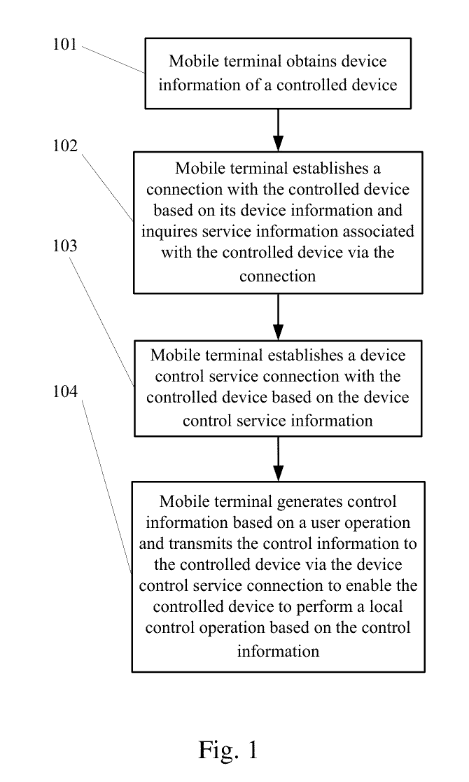

The embodiments can provide a device control service capability on a LAN. To provide this capability, problems relating to device discovery, service inquiry, control command transmission, and network connection need to be resolved. FIG. 1 illustrates the exemplary steps in a device control method that resolves these problems. The method can include the following steps.

101: A mobile terminal can obtain device information of a controlled device.

In particular, when discovering a device on a LAN, the method can include, for example, the mobile terminal transmitting a broadcast over the LAN to search for devices connected to the LAN; after receiving the broadcast, a device on the LAN responding to the mobile terminal with its device information by using the address and port number in the broadcast.

When both the mobile terminal and another device (e.g., a controlled device) are connected to the LAN and logged into an application using the same account, e.g., when both the mobile terminal and another device on the LAN use a public account to log into an application, the method can further include, for example, the mobile terminal inquiring device information of the other device logged into the public account based on the public account to establish a connection with the other device to enable device control.

That is, the mobile terminal can obtain device information through shared login account and connect to the other device over a LAN or WAN using the device information to obtain service information of the device. A device control service connection with the device can then be established to enable controlling of the device.

102: The mobile terminal can establish a connection with the controlled device based on its device information and inquire service information associated with the controlled device via the connection. The service information can include device control service information.

103: The mobile terminal can establish a device control service connection with the controlled device based on the device control service information.

In particular, the device information obtained in step 101 can include a device information chart of multiple devices. The corresponding device control service information can include a device control service information chart of multiple devices. This step can include, for example, the mobile terminal establishing device control service connections with the multiple devices separately based on the device control service chart to allow the mobile terminal to switch its control target quickly. That is, the mobile device can quickly switch among the multiple devices and perform device control operations.

In other aspect, the device control service information of the above-described devices can include the port number of the device control service port of each device. When establishing a connection with each device, the mobile terminal can establish a device control service connection with the device control service port of the device based on the port number.

104: The mobile terminal can generate control information based on a user operation and transmit the control information to the controlled device via the device control service connection to enable the controlled device to perform a local control operation based on the control information.

For example, the user operation can include a multi-point touch and/or gesture operation. The mobile terminal can generate operation information corresponding to the user operation and transmit the encapsulated operation information to the controlled device. Alternatively, the mobile terminal can generate the specific control command corresponding to the operation information after generating the operation information and then transmit the encapsulated control command to the controlled device.

That is, this step can include, for example, the mobile terminal generating control information based on a user's multi-point touch and/or gesture operation. The control information can include multi-point touch and/or gesture information to allow the controlled device to generate a corresponding control command based on the control information and to execute the control command.

Alternatively, the mobile terminal can generate multi-point touch and/or gesture information based on a user's multi-point touch and/or gesture operation, and generate control information based on the multi-point touch/gesture information. The control information can include a control command corresponding to the multi-touch touch and/or gesture operation to allow the controlled device to perform the control command after receiving the control information.

For example, if the user gesture is a single-finger movement, the mobile terminal can generate single-finger movement information based on this operation to indicate that the current user operation includes a single-finger movement. Then, the mobile terminal can transmit this information directly to the controlled device, or transmitting a control command to the controlled device after converting this information into a corresponding control command (e.g., a cursor movement command). The exact implementation can depend on the device control protocol agreed upon between the mobile terminal and the controlled device, and can be configured or regulated based on individual circumstances.

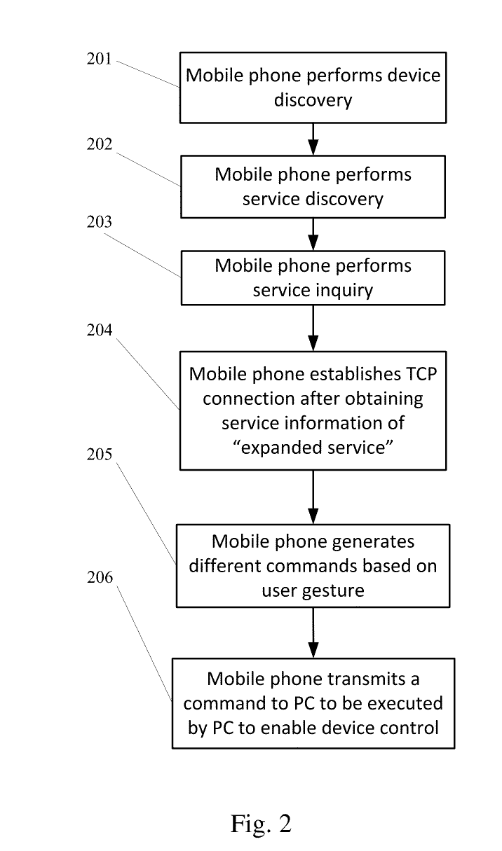

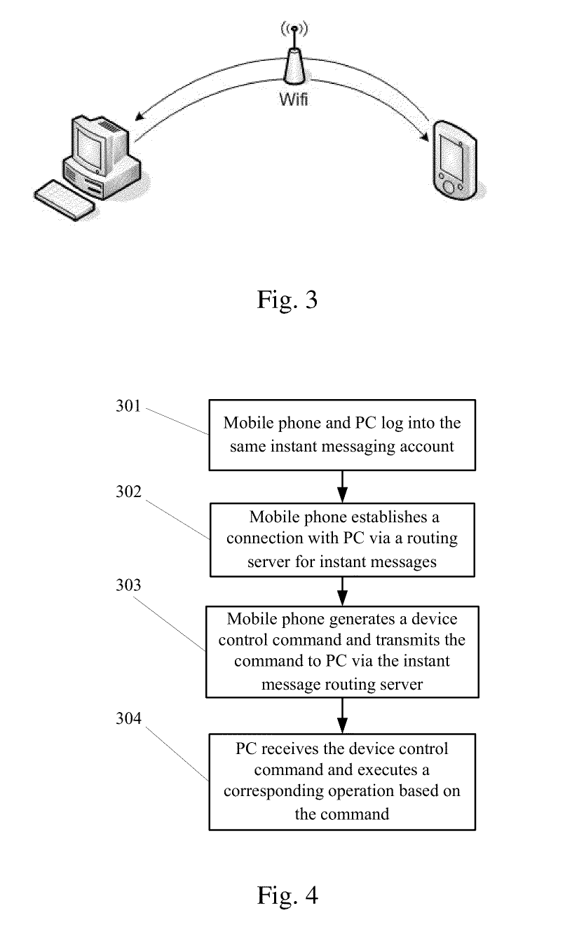

FIG. 2 is a flow chart illustrating the exemplary steps of a device control method on a LAN. In this embodiment, the LAN can be a Wi-Fi network. The mobile terminal can be a mobile phone. The device on the LAN can be a PC. FIG. 3 illustrates an embodiment in which the mobile phone and the PC are connected via the Wi-Fi network. The method can include the following exemplary steps.

201: Device discovery. For example, after the mobile phone starts a particular program (e.g., a controller application of a device control service), it can transmit a broadcast in, for example, the user datagram protocol (UDP) via the LAN to discover other devices on the network. When the PC receives the broadcast, it can return device information based on the IP address and port number of the mobile phone. The device information can include the port number and IP address of the PC.

202: Service discovery. For example, the mobile phone can attempt to establish a transmission control protocol (TCP) connection to the specific port of the device (e.g., the PC) discovered in step 201. After the connection is successfully established, the mobile phone can inquire the service information of the device (e.g., the PC) via the connection.

203: Service inquiry, more specifically, discovering device control services. For example, the mobile phone can obtain the service port number of the “expanded service” (in this embodiment, the expanded service can be, for example, a device control service).

204: After obtaining the service information of the “expanded service,” the mobile phone can attempt to establish a TCP connection with the port number of the expanded service of the device (e.g., the PC). After successfully establishing the connection, the mobile phone can prepare to transmit control information.

205: The mobile phone can generate different commands based on the user's gestures. The command can be for, for example, cursor movement, downward scrolling of a page, upward scrolling of a page, and closing the current application. The gesture can be self-defined. For example, as defaulted, single-finger movement can be associated with cursor movement; two-finger upward movement can be associated with an upward scrolling of a page; two-finger downward movement can be associated with a downward scrolling of a page; and three-finger simultaneous touch can be associated with closing the current application. It should be understood that, in this embodiment, the mobile device (e.g., the mobile phone) can generate different commands based on a user's touch operations.

206: The mobile phone can transmit the command to the PC to be executed by the PC to enable device control.

FIG. 4 is a flowchart illustrating the exemplary steps of an embodiment, in which the mobile terminal (e.g., a mobile phone) and the controlled device (e.g., a PC) are connected via a WAN.

301: the mobile phone and the PC can log into the same instant messaging account. The mobile phone can detect the one or more devices logged into the same instant messaging account for the purpose of discovering a controlled device.

302: The mobile terminal can establish a connection with the PC via a routing server for instant messages. When a device (e.g., the PC) is discovered in step 301, the information of the device can include an address on the LAN. And if the mobile phone and the PC are on the same LAN, the mobile phone can utilize the method of steps 202-206 discussed above to facilitate the follow-up device control process. Otherwise, the mobile phone can provide device control by following step 303.

303: The mobile phone can generate a device control command and transmit the command to the PC via the instant message routing server. It should be noted that the mobile phone can accurately transmit the command to the PC if the instant messaging application includes a device control function.

The exemplary ways in which the mobile phone can generate a command are described in the embodiments above and therefore not provided again here.

304: The PC can receive the device control command and execute a corresponding operation based on the command.

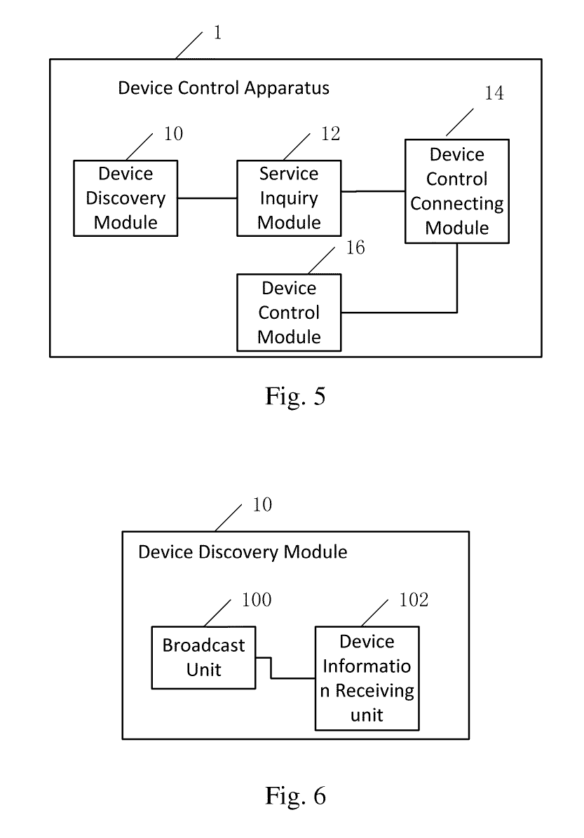

FIG. 5 is a structure diagram of a device control apparatus, according to an embodiment of the disclosure. The device control apparatus can be part of the mobile terminal. The apparatus can include: a device discovering module 10 that can obtain device information of a controlled device; a service inquiry module 12 that can inquire service information associated with the controlled device based on the device information and the established connection, the service information including device control service information; a device control connecting module 14 that can establish a device control service connection to the controlled device based on the device control service information; and a device control module 16 that can generate control information based on a user operation and transmit the control information to the controlled device over the device control service connection to allow the controlled device to perform local control based on the control information.

In some embodiments, the device information can include a device information chart of multiple devices. The device control service information can include a device control service information chart of the multiple devices. The device control connecting module 14 can establish device control service connections to the multiple devices, separately, based on the device control service information chart to allow the mobile terminal to switch quickly among the multiple device control targets. When the device control service information include the port number of the device control service port, the device control connection module 14 can establish a device control service connection to the device control service port of the controlled device based on the port number.

The user operation can include a multi-point touch and/or gesture operation. The device control module 16 can also generate control information based the multi-point touch and/or gesture operation. The control information can include multi-point touch and/or gesture information to allow the controlled device to generate a control command corresponding to the control information and execute the control command.

Alternatively, the device control module 16 can generate multi-point touch and/or gesture information based on the multi-point touch and/or gesture operation, and generate control information based on the multi-point touch and/or gesture information. The control information can include a control command corresponding to the multi-touch and/or gesture control operation and when received by the controlled device, allow the control device to execute the command.

As illustrated in FIG. 6, the device discovery module 10 can also include: a broadcast unit 100 that can transmit broadcast over the LAN to discover devices; and a device information receiving unit 102 that can receive device information returned from a device on the LAN to the mobile terminal based on the mobile terminal's address and port number in the broadcast, after the device receives the broadcast. The device discovery module 10 can also include an account discovering unit that can inquire, based on a public account, device information of a device associated with the public account, when the mobile terminal and the controlled device log into an application using the public account. FIG. 6 illustrates a device discovery module including only the broadcasting unit and the device information receiving unit. However, the device discovery module can also include only the account discovering unit or all three of these units.

Embodiments of the disclosure also disclose a mobile terminal including the device control apparatus described above.

It should be noted that the technical details and functions of the above-described apparatus can be the same as the steps in the processes described above and, thus, are not repeated here.

In the embodiments, the device control process can be realized through processes including, for example, discovering a device, discovering the device's device control service, and generating and transmitting of control information. This can provide a technical solution of device control among different devices, thereby solving the problems with the existing technology and increasing the interactions among the devices on a LAN.

At the same time, the embodiments can also support mobile terminal performing device control using multi-point touch and/or gesture operations. When the condition of the network allows, the mobile terminal can also control a device via both a LAN and a WAN. When performing device control, the mobile terminal can connect to multiple terminals at the same time to allow fast switching of the control target.

Based on the above-described embodiments, a person skilled in the art can understand that parts of or the whole process described in each of the above embodiments can be performed by hardware in accordance with instructions from one or more computer programs. The one or more computer programs can be stored in a non-transitory readable medium, and when executed, perform the processes described in these embodiments. The non-transitory computer readable medium can be a floppy disk, CD, read-only memory (ROM), or random access memory (RAM).

In some embodiments, one or more of the modules in FIGS. 5 and 6 can be stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this file, a “non-transitory computer-readable storage medium” can be any medium that can contain or store the program for use by or in connection with the instruction execution system, apparatus, or device. The non-transitory computer readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

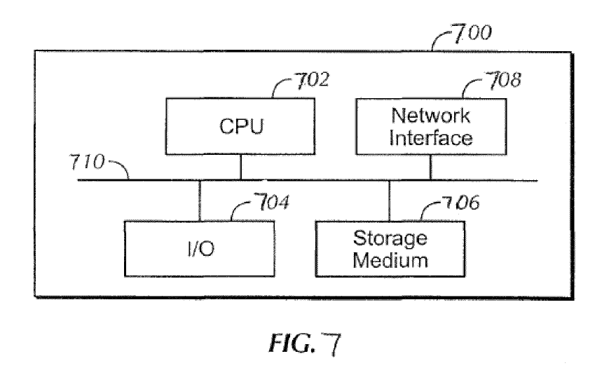

The non-transitory computer readable storage medium can be part of a computing system serving as the device control apparatus. FIG. 7 illustrates exemplary common components of one such computing system. As illustrated, the system 700 can include a central processing unit (CPU) 702, I/O components 704 including, but not limited to one or more of display, keypad, touch screen, speaker, and microphone, storage medium 706 such as the ones listed in the last paragraph, and network interface 708, all of which can be connected to each other via a system bus 710. The storage medium 706 can include the modules of FIGS. 5 and 6 if the system is a device control apparatus in one of the embodiments discussed above.

Although embodiments of this disclosure have been fully described with reference to the accompanying drawings, it is to be noted that various changes and modifications will become apparent to those skilled in the art. Such changes and modifications are to be understood as being included within the scope of embodiments of this disclosure as defined by the appended claims.

What is claimed is:

1. A device control method, comprising:
a mobile terminal obtaining device information associated with a controlled device,
the mobile terminal establishing a connection with the controlled device based on the obtained device information and inquiring service information of the controlled device via the established connection, the service information comprising device control service information,
the mobile terminal establishing a device control service connection with the controlled device based on the device control service information, and
the mobile terminal generating control information based on a user operation and transmitting the control information to the controlled device via the device control service connection to control the controlled device based on the control information.

2. The method of claim 1, wherein the user operation comprises a multi-point touch and gesture operation, and wherein the mobile terminal generating control information based on the user operation comprises:
the mobile terminal generating control information based on the user's multi-point touch and/or gesture operation to allow the controlled device to generate a corresponding control command based on the control information and execute the control command, or
the mobile terminal generating multi-point touch and/or gesture information based on a user's multi-point touch and/or gesture operation, and generating control information based on the multi-point touch and/or gesture information, the control information comprising a control command corresponding to the multi-point touch and/or gesture operations, to allow the controlled device to execute the control command after receiving the control command.

3. The method of claim 1, wherein the device information comprises a device information chart of multiple devices, the device control service information comprises a device control service chart of multiple devices, and wherein the mobile terminal establishing the device control service connection with the controlled device based on the device control service information comprises:
the mobile terminal establishing device control service connections with multiple devices, separately, based on the device control service information chart to allow the mobile terminal to switch a device control target.

4. The method of claim 1, wherein the mobile terminal obtaining device information associated with the controlled device comprises:
the mobile terminal transmitting a broadcast over the LAN to search for devices,
when a device on the LAN receives the broadcast, responding with its device information to the mobile terminal using an address and port number in the broadcast.

5. The method of claim 1, wherein the mobile terminal obtaining the device information associated with the controlled device comprises:
when the mobile terminal and the controlled device log into an application via a public account, the mobile terminal inquiring device information of a device logged into the public account to establish a connection with the device for facilitating device control.

6. The method of claim 1, wherein the device control service information comprises a port number of a device control service port, and wherein the mobile terminal establishing the device control service connection with the controlled device based on the device control service information comprises:
the mobile terminal establishing a device control service connection with the device service control port of the controlled device based on the port number.

7. A device control apparatus in a mobile terminal, the apparatus comprising:
a device discovering module that obtains device information of a controlled device,
a service inquiry module that inquires service information associated with the controlled device based on the device information and the established connection, the service information comprising device control service information,
a device control connecting module that establishes a device control service connection to the controlled device based on the device control service information, and
a device control module that generates control information based on a user operation and transmits the control information to the controlled device over the device control service connection to allow the controlled device to perform a local control operation based on the control information.

8. The apparatus of claim 7, wherein the user operation comprise a multi-point touch and/or gesture operation, and
wherein the device control module
generates control information based the multi-point touch and/or gesture operation, the control information comprising multi-point touch and/or gesture information to allow the controlled device to generate a control command corresponding to the control information and execute the control command, or
generates multi-point touch and/or gesture information based on the multi-point touch and/or gesture operation, generates control information based on the multi-point touch and/or gesture information, the control information comprising a control command corresponding to the multi-touch and/or gesture control operation, the control command executable after it is received by the controlled device.

9. The apparatus of claim 7, wherein the device information comprises a device information chart of multiple devices, the device control service information comprises a device control service information chart of the multiple devices, and
wherein the device control connecting module establishes device control service connections to the multiple devices, separately, based on the device control service information chart to allow the mobile terminal to switch a device control target.

10. The apparatus of claim 8, wherein the device discovering module comprises:
a broadcast unit that transmits a broadcast over the LAN to discover devices, and
a device information receiving unit that receives device information returned from a device on the LAN to the mobile terminal based on the mobile terminal's address and port number included in the broadcast, after the device receives the broadcast.

11. The apparatus of claim 7, wherein the device discovering module comprises:
an account discovering unit that inquires device information of a device associated with a public account based on the public account when the mobile terminal and the controlled device log into an application using the public account.

12. The apparatus of claim 7, wherein the device control service information comprises a port number of a device control service port, and wherein the device control connecting module establishes a device control service connection to the device control service port of the controlled device base on the port number.

13. A remote control device, comprising:
an input/output (I/O) device that receives a user input,
a network interface that connects the remote control device to a network,
a broadcast module that sends a message via the network interface to the network,
an information receiving module that receives device information and service information from the network via the network interface,
a device control connecting module that establishes a connection to a device on the network based on the received device information and service information, and
a device control module that generates control information based on a user operation and transmits the control information to the device over the established connection.

14. The remote control device of claim 13, wherein the user input comprises at least one of a touch input, gesture input, text input, audio input, and visual input.

15. The remote control device of claim 13, wherein the received service information is associated with a device control service provided by the device on the network.

16. The remote control device of claim 13, wherein the device information comprises connection information that enables a connection with the device.

17. A remote device control method comprising:
receiving login information associated with an account from a first terminal and a second terminal over a network,
allowing the first terminal and the second terminal to log into the account based on the login information,
receiving a request from the first terminal to identify one or more other terminals logged into the account,
identifying the second terminal to the first terminal as another terminal logged into the account, device information from the second terminal to the first terminal in response to the discovery broadcast, and
routing device control information from the first terminal to the second terminal.

18. The remote device control method of claim 17, comprising:
receiving verification that the second terminal provides a remote control service, and
informing the first terminal regarding the verification.

19. The remote device control method of claim 17, wherein identifying the second terminal to the first terminal comprises transmitting device information associated with the second terminal to the first terminal.

20. The remote device control method of claim 17, wherein the device control information comprises a device control command for performing an operation on the second terminal.
